(19) United States
(12) Patent Application Publication
(10) Pub. No.: US 2014/0293603 A1
(43) Pub. Date: Oct. 2, 2014

(54) LED LIGHT BULB REPLACEMENT WITH ADJUSTABLE LIGHT DISTRIBUTION

(71) Applicant: Sensity Systems, Inc., Sunnyvale, CA (US)

(72) Inventors: Chris W. Barnard, Sunnyvale, CA (US); Ezra Gold, Sunnyvale, CA (US); Victor Santashev, Maple (CA)

(73) Assignee: Sensity Systems, Inc., Sunnyvale, CA (US)

(21) Appl. No.: 14/202,849

(22) Filed: Mar. 10, 2014

Related U.S. Application Data
(60) Provisional application No. 61/805,595, filed on Mar. 27, 2013.
(60) Provisional application No. 61/805,645, filed on Mar. 27, 2013.

(51) Int. Cl. F21K 99/00; F21V 29/00

(52) U.S. Cl. CPC F21K 9/50; F21K 9/1355; F21V 29/2206
USPC 362/241; 362/249.02; 362/237

(57) ABSTRACT

An LED lightbulb retrofit is described that can be adjusted to (a) to accommodate both top-socket and bottom-socket applications, (b) generate a variety of IESNA illumination distributions, (c) generate different levels of total lumens, (d) mount to different sockets such as medium and mogul bases, (e) and work in both refractors and globe fixtures. LED printed circuit boards are mounted on multiple exterior surfaces of a single heat sink with internal fins that can be cut to different lengths to accommodate different numbers of PCBs with a parallel connector mounted (a) symmetrically for symmetrical lighting distributions or (b) asymmetrically for asymmetrical lighting distributions. LED light is controlled by an adjustable array of reflectors or lenses located over the LEDs.

### RELATED APPLICATIONS

The present application claims the benefit of priority to U.S. Provisional Application No. 61/805,595, entitled “LED Light Bulb Replacement with Adjustable Light Distribution,” filed Mar. 27, 2013, and U.S. Provisional Application No. 61/805,645, entitled “Natural Convention Cooling of LED Luminaires,” filed Mar. 27, 2013, the entire contents of which are hereby incorporated by reference.

### BACKGROUND OF THE INVENTION

The invention relates to lighting systems and, in particular, to a light emitting diode (LED) retrofit for an incandescent or fluorescent light bulb.

### SUMMARY OF THE INVENTION

Various embodiments may include a light emitting diode (LED) light bulb replacement apparatus that may include a plurality of circuit boards or chip on board modules (or COB modules) upon which LEDs may be mounted, a multi-sided heat sink with internal fins, wherein one or more circuit boards or chip on board modules may be mounted on one or more sides of the heat sink, the heat sink being arranged about an axis with the fins on the heat sink facing the axis to allow convective air flow across the fins, an airflow cavity defined by a volume around the axis and inside the fins of the heat sink, and opposite ends of the axis being open to enable airflow through the airflow cavity along the fins of the heat sink. In some embodiments, the internal fins may be ribbed to increase a surface area of the fins without significantly impeding an air flow cross-sectional area. In some embodiments, the heat sink may be attached to one of a plurality of interchangeable mechanical bases that can be mounted in or on legacy light sockets, and the interchangeable mechanical bases have arms mounting to the heat sink that do not significantly block air flow through the airflow cavity. In some embodiments, the LEDs may be mounted on the plurality of circuit boards, and a total number of the circuit boards on each side of the heat sink may be adjusted to approximate an ideal light distribution. In some embodiments, the LEDs may be mounted on the plurality of the chip on board (COB) modules. In some embodiments, the heat sink being attached to one of a plurality of interchangeable mechanical bases that can be screwed into legacy light sockets, a rotational orientation of the heat sink relative to a light fixture being adjustable by a set screw, a total number of LED circuit boards being adjusted by a parallel output connector and cutting a length of the heat sink, and a light distribution in a plane orthogonal to the axis being adjusted by mounting the plurality of circuit boards or chip on board modules symmetrically or asymmetrically on the one or more sides of the heat sink. In some embodiments, the light distribution in the plane containing the axis may be adjusted by an array of reflective flaps with adjustable angles, and wherein the array of reflective flaps may be positioned such that each flap in the array of reflective flaps reflects a substantial amount of rays from a single LED. In some embodiments, the light distribution in the plane containing the axis may be adjusted by a plurality of lenses positioned such that each lens focuses a substantial amount of rays from a single LED, and each lens has a different mounting orientation relative to the LEDs.

In other embodiments, a light emitting diode (LED) light bulb replacement apparatus may include a plurality of circuit boards or chip on board modules upon which LEDs may be mounted, and an array of reflective flaps mounted over the plurality of circuit boards or chip on board modules such that each flap reflects a significant portion of rays from one or more LEDs towards an illumination area, wherein an angle and a shape of each reflective flap can be adjusted to control a distribution of reflected rays reflected by the each reflective flap.

In other embodiments, a light emitting diode (LED) light bulb replacement apparatus may include a plurality of circuit boards or chip on board modules upon which LEDs may be mounted, and a plurality of directional lenses with each lens mounted over the plurality of circuit boards or chip on board modules so as to direct a substantial amount LED light rays in a preferred direction, wherein the mounting of the lenses may be adjustable so that more than one preferred direction can be achieved by mounting the lenses with more than one orientation.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a schematic perspective view of light distributions relative to two post top luminaires.

FIG. 2 is a schematic top view of IESNA classification of roadway light distributions.

FIGS. 3A and 3B are side views of respective conventional pendant and post top luminaires and FIGS. 3C and 3D are plots of their ideal candela distributions versus vertical angle.

FIG. 4 is a mechanical drawing of part of one embodiment of the LED lightbulb replacement (or LED retrofit).

FIG. 5 is a perspective view of details of the first embodiment of the extruded heat sink used in the LED lightbulb replacement.

FIG. 6 is a perspective view of the heat sink/PCB assembly coupled with the LED driver and surge protector device.

FIG. 7 is a wiring diagram of the LED PCB used in the lightbulb replacement.

FIG. 8 is a wiring diagram of an embodiment of the LED lightbulb replacement with one driver and six LED PCBs, with one PCB on each side of the heat sink for a Type V light distribution.

FIG. 9 is a wiring diagram of an embodiment of the LED lightbulb replacement with two drivers and twelve LED PCBAs, with one PCB on each side of the heat sink for a Type V light distribution.

FIG. 10A is a perspective view of details of the reflector array used in post top applications of the LED lightbulb replacement, and FIGS. 10B-10E are plots of candela distribution versus vertical angle.

FIGS. 11A and 11B are perspective views of the pendant configuration of the LED lightbulb replacement.

FIG. 12A is a side view of details of the reflector array used in pendant applications of the LED lightbulb replacement, and FIGS. 12B and 12C are plots of candela distribution versus angle.

FIGS. 13A and 13B are respective schematic side and perspective views of the PCB placement, and FIG. 13C is a candela plot of the post top application with Type III light distribution.

FIG. 14 is a wiring diagram of an embodiment of the LED lightbulb replacement with one driver and six LED PCBs, with the PCBs arranged to provide a Type V light distribution.

FIGS. 15A and 15B are respective plan and side views of the adjustment screw used to orient control the rotation of the LED retrofit relative to the illumination area.

FIGS. 16A, 16B, and 16C are perspective views of embodiments of the LED lightbulb replacement that uses directional lenses to direct the light towards the illumination area.

### DETAILED DESCRIPTION OF THE PREFERRED EMBODIMENTS

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

Background Terminology

The invention described here provides means of controlling the light distribution of an LED retrofit that replaces the legacy lighting technology in a lighting fixture or luminaire. As such certain terminology is used. The lux is a measure of illuminance and luminous emittance set by the International System of Units (“SI”) described in terms of luminous flux per unit area. One lux is equal to one lumen per square meter.

The candela is an SI defined unit of luminous intensity; that is, power emitted by a light source in a particular direction, weighted by the “luminosity function.” The luminosity function is a standardized model of the sensitivity of the human eye to different wavelengths, sometimes also called the luminous efficiency function. A common candle emits light with a luminous intensity of roughly one candela. If an opaque barrier blocks emission in a direction, the emission is still approximately one candela in the directions that are not obscured.

The lumen is an SI derived unit of luminous flux, a measure of the total “amount” of visible light emitted by a source. Luminous flux differs from power (radiant flux). Luminous flux measurements reflect the varying sensitivity of the human eye to different wavelengths of light, while radiant flux measurements indicate the total power of all light emitted, independently from the eye's ability to perceive it. The lumen is defined in relation to the candela as 1 lumen equals=1 candela steradian. Because a sphere has a solid angle of 4·π steradians, a light source that uniformly radiates one candela in all directions has a total luminous flux of 1 cd·4π sr=4π≈12.57 lumens.

In this application “LED lightbulb replacement” and “LED retrofit” are used interchangeably to indicate the apparatus that replaces the lightbulb inside a lighting fixture.

It is desirable to upgrade currently installed incandescent and compact fluorescent light bulbs to LED lights for several reasons: (1) efficiency—LED technology delivers more lumens per Watt than other lighting technologies so that the same illumination can be obtained with significantly lower power consumption; (2) reliability—LED technology has statistically much longer lifetimes than other technologies so that it requires fewer hardware replacements and lower maintenance costs; (3) directionality—as a point source, it is easier to direct LED light with lenses and reflectors so that the light can be concentrated on the desired illumination area and excluded from areas where it is not desired; and (4) adjustability—LED light levels can be dimmed, and colors can be controlled via software and hardware controls.

Prior art examples of LED lighting include the following. U.S. Pat. No. 8,646,944 describes a standalone LED luminaire for achieving a desired illumination pattern where LED panels are rotatable in at least two dimensions. US 2013/0250575 describes a linear LED lens array that can be used to direct light towards an illumination area. US 2012/0281405 describes a low-glare LED luminaire with translucent lenses. U.S. Pat. No. 8,496,360 describes an LED luminaire that uses a combination of lenses and a reflector to direct light towards an illumination area. U.S. Pat. No. 8,403,533 describes an LED module that can be rotated along one axis to point the light towards an illumination area. U.S. Pat. No. 8,534,867 describes an LED luminaire that uses an array of parabolic reflectors to direct the light towards an illumination area.

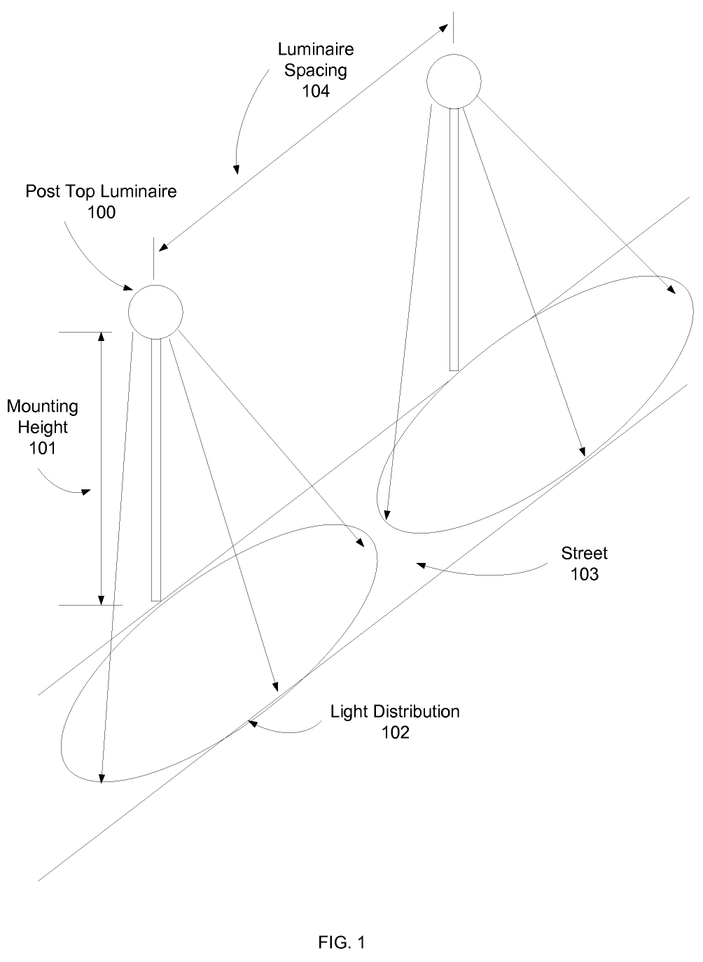

FIG. 1 shows and example of one lighting application where post top luminaires 100 are lighting a street area 103. The light distribution 102 obtained on the ground below the post top lamps depends on the type of bulb and Wattage of the bulb in the fixture, the optical properties of the fixture, the mounting height 101, and the luminaire spacing 104. Ideally, the post top luminaire would evenly illuminate the desired area with minimal light being absorbed within the fixture or directed in other directions.

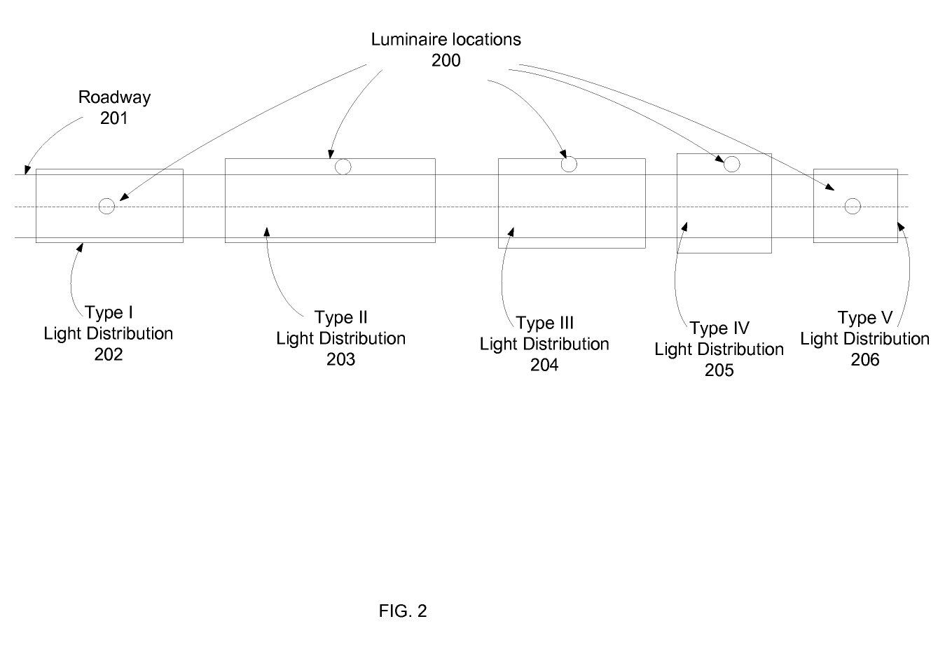

FIG. 2 shows a top view of the five categories of roadway lighting distributions as defined by the Illumination Engineering Society of North America (IESNA). Type 1 illumination 202 is a rectangular distribution below the luminaire that spreads the light along the length of the roadway 201. Type II illumination 203, Type III illumination 204, and Type IV illuminations 205 spread the light along the length of the roadway, but with some forward throw so as to light the roadway in front of the luminaire for applications where the luminaire is mounted on the side of the roadway. Type II, III, and IV differ in the spreading of light along the roadway as shown in FIG. 2. Type V illumination 206 spreads the light evenly in a square pattern underneath the luminaire. Luminaire manufacturers have different product models that provide the different lighting distributions. Furthermore, for a certain IESNA category, luminaire manufactures have different models to provide varying amounts of lumens, and to provide different degrees of lateral spreading of the light.

Many lighting customers that want to take advantage of LED technology also want to keep the legacy lighting fixture so as to reduce cost, reduce waste, and maintain the architectural integrity of decorative fixtures. Therefore, there is demand for LED products that retrofit the lightbulb within the fixture while re-using the outer fixture.

Conventional lighting uses omnidirectional bulbs with reflectors and/or refractors to direct the light from the bulb in the desired illumination distribution. LED luminaire manufactures design luminaires for a given light distribution (1) by orienting the LEDs in the desired direction or (2) by adding lenses with the required light distribution. These designs can direct the LED light in the required direction, but if a different direction is required a different product must be ordered. Also, when the prior art luminaires are installed, the light distribution cannot be adjusted on site. It would be desirable to provide a single fixture that is adjustable on site to meet the needs of the site depending on the type of lighting distribution, pole spacing, and mounting height.

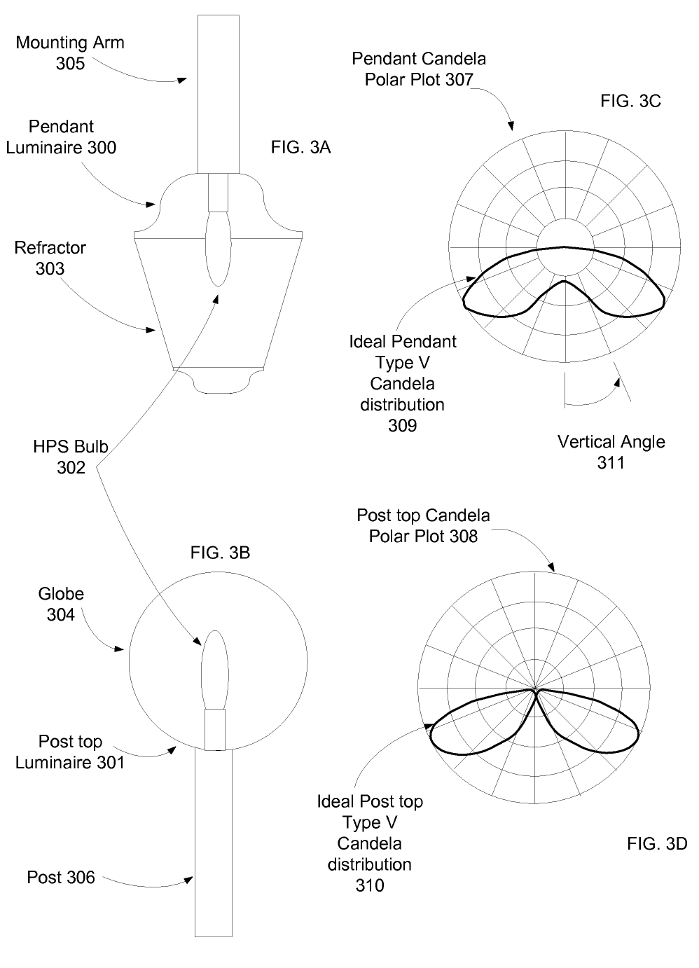

FIGS. 3A and 3B show examples of two types of conventional luminaires, a pendant luminaire 300 and a post top luminaire 301, respectively. The pendant luminaire 300 is suspended by a mounting arm 305 and has a high-pressure sodium (HPS) or other bulb 302 hanging downwards in a glass refractor 303. The post top luminaire 301 has its bulb 302 standing on a base attached to a post 306 with the bulb inside a glass or plastic globe 304 or refractor. The optimum light distribution of an LED lightbulb retrofit depends on the fixture (post top or pendant) as well as the illumination area. The ideal pendant Type V distribution 309 is shown in the polar candela plot 307 in FIG. 3C where the vertical angle 311 of zero denotes the rays straight down from the luminaire. To achieve an even Type V distribution 309, the refractor must direct the light rays more towards the horizon, with some rays directed straight downwards as well. The ideal post top Type V distribution 310 is shown in the polar candela plot 308 in FIG. 3D. To achieve an even Type V distribution 310, the refractor or globe must direct the rays towards the horizon, with no light being directed straight down since that light will be absorbed by the pole 306. To limit uplight (light above the horizon), a pendant replacement should direct more light away from the socket and a post top replacement should direct more light towards the socket with a dark spot directly underneath so as not to waste light energy that would be absorbed by the pole. Depending on the type of bulb and Wattage, conventional luminaires can have different socket geometries and sizes, such as medium and mogul Edison sockets. Retrofit LED products must accommodate these different sockets.

LEDs convert electrical energy into light, but with undesired heat (albeit in a smaller quantity than incandescent light bulbs). The power supply for the LED, which typically converts incoming alternating current power to direct current, also creates heat. The LED power supplies are typically 80% to 90% efficient, with the remaining 10-20% of incoming energy converted to heat. The excess heat generated by the LEDs and the power supply reduces the light output and product lifetime. To limit the temperature increase, LED luminaires typically use a passive heat sink with fins that are convection cooled by the surrounding air as it flows over the fins. In some installations, however, the LED assembly operates in an enclosed fixture, for example, a post top luminaire. In these installations there is limited airflow because the air is constrained inside the cover of the luminaire. In these installations the excess heat is transferred from the LEDs and the heat sink to the air, then from the air to the luminaire cover or base, and finally from the cover or base to the outside air. One well-known method of improving heat transfer is to place a fan inside the luminaire to circulate the air. Because of the additional component, use of a fan can potentially reduce the lifetime of the LED/fan combination. In some installations the noise generated by the fan is undesirable. The fan also adds extra cost as a result of the fan and its power supply. Furthermore, in some installations the size of the fan limits the deployment to applications where the luminaire is large enough to contain the additional components.

To minimize inventory and lower manufacturing costs by using component parts in high volume, there is therefore a need for an LED lightbulb retrofit that can be (a) adjusted for both top-socket and bottom-socket applications, (b) adjusted to generate a variety of IESNA illumination distributions, (c) adjusted to different levels of total lumens, (d) adjusted to mount to different sockets such as medium and mogul bases, and (e) adjusted to work in both refractors and globes. The retrofit must have good thermal design so as to enhance the natural convection flow within the fixture to maintain the LED and power supply temperatures at acceptable levels.

Various methods and apparatus of the embodiments of the invention relate to an LED light bulb replacement that can be installed in various lighting fixtures while providing adjustable output light distribution so as to optimize the light distribution with regards to the retrofitted lighting fixture, mounting height, pole spacing, and illumination area.

This invention discloses an apparatus for replacing conventional light bulb with LED-based retrofits. LED chips are mounted on printed circuit boards (PCBs) that are mounted on an extruded aluminum heat sink. The heat sink has an enclosed chimney area with fins located in a cavity about a central axis so that the air enters from below and rises to the top of the cavity by natural convection. The heat sink has a two-dimensional extrusion profile that can be cut to different lengths so that a different number of PCBs can be mounted to provide different lumen levels. Different numbers of PCBs can be mounted on different sides of the heat sink so as to provide the different categories of lighting distributions. The PCB design has connectors and traces designed so that the PCBs can be connected in parallel to one or more constant-current direct-current power supplies (henceforth referred to as “drivers”). To improve thermal performance, the driver is mounted separately from the LED heat sink in a plastic holder. Interchangeable bases enable the same retrofit to be mechanically mounted in different conventional sockets such as the standard Medium E26 socket or the mogul E39 socket. For asymmetrical distributions, a set screw in the mechanical base enables the retrofit to be oriented along a desired direction.

In one embodiment, an array of flexible reflectors stamped in a metal sheet is placed on top of the LED PCBs so as to reflect the light towards the illumination area in an adjustable manner. In another embodiment, reversible lenses that are placed on top of each LED also provide a means of adjusting the light distribution relative to the mounting socket. The number of LEDs on the circuit boards is chosen to match the direct-current voltage from the power supply.

The embodiment features may include one or more of a heat sink with fins in the middle, ribs on the heat sink, single extrusion cut to different lengths for different amounts of total lumens, PCBs connected in parallel with cascade connector, flaps with different angles, tool to adjust the flap angle, curved flaps, selective placement of LED board to get different light distributions, adjustment screw to set orientation vs. the street side, lenses and flaps can be flipped around for post top and pendant, interchangeable bases for different socket types, vertical heat sink with downwards light, low glare from many low-power LEDs (reflector instead of lens), slots on the heat sink so that drilling/tapping is not required, and driver caddy, mounted separate from the LEDs.

In various embodiments described herein, ribbed fins of heat sinks may increase a surface area without significantly impeding or blocking air flow. Additionally, in various embodiments, mechanical bases having arms mounted to a heat sink as described herein may not significantly impede or block air flow through an airflow cavity defined by a volume about an axis and inside the fins of such a heat sink. For the purpose of this disclosure, such substantially impeding (or a substantial impedance) may be considered an increase to impedance greater than 10% (e.g., embodiments may only increase impedance less than 10%). Further, various embodiments may include adjusting circuit boards on the sides of heat sinks to approximate an ideal light distribution. For the purpose of this disclosure, such an approximate may be considered to be within 10% of an ideal light distribution.

Although the exemplary descriptions of this disclosure may refer to metal heat sinks fabricated by an extrusion method, it should be appreciated that heat sinks may be fabricated by other methods, such as stamping or die casting, and thus the embodiments are not intended to be limited to heat sinks fabricated by extrusion fabrication methods.

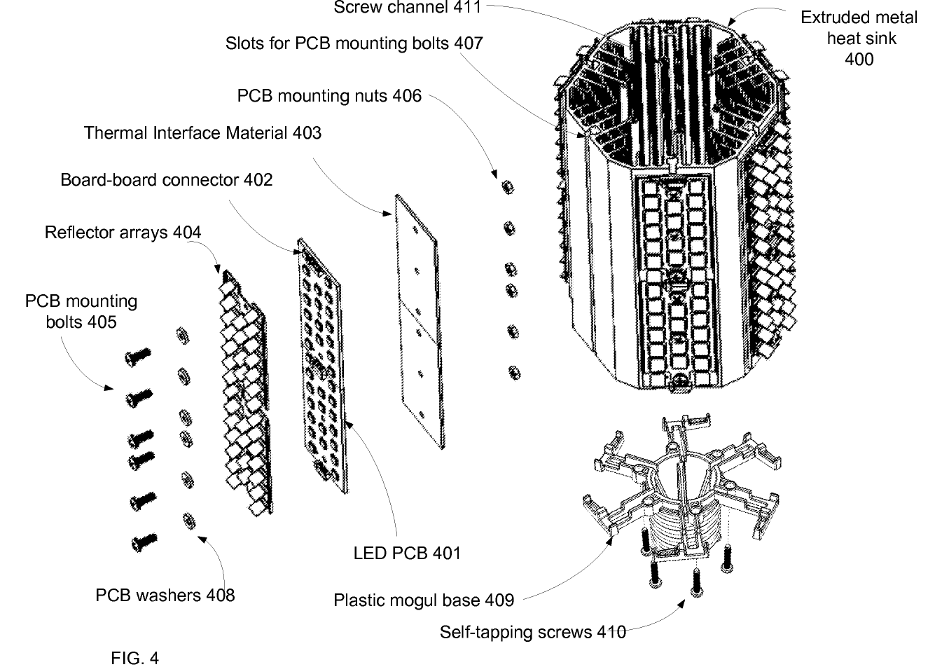

FIG. 4 is a mechanical drawing of one embodiment of the invention. LED chips are mounted on a PCB 401 with a board-to-board electrical connector 402 that allows LED PCBs to be cascaded with a parallel electrical connection. The LED boards are mounted on an extruded aluminum heat sink 400 that has slots for the PCB mounting nuts 406. The slots lower the product cost since they remove the need to drill screw holes in the heat sink. The PCB mounting bolts 405 clamp the LED PCBs to the heat sink over a thermal interface material 403 that improves the conductive heat transfer from the PCBs to the heat sink. Optional reflector arrays 404 can be placed over the LED PCBs to adjust the light distribution. A plastic molded base 409 is attached to the base of the heat sink 400 with self-tapping screws 410 that are screwed directly into the screw channels 411 of the heat sink. The molded base is designed to fit in standard Edison sockets, but without electrical contact. Different bases are used to mount the LED retrofit in different size bases without changing any of the other components. In another embodiment, a non-threaded base can be attached directly to the base of the retrofitted fixture.

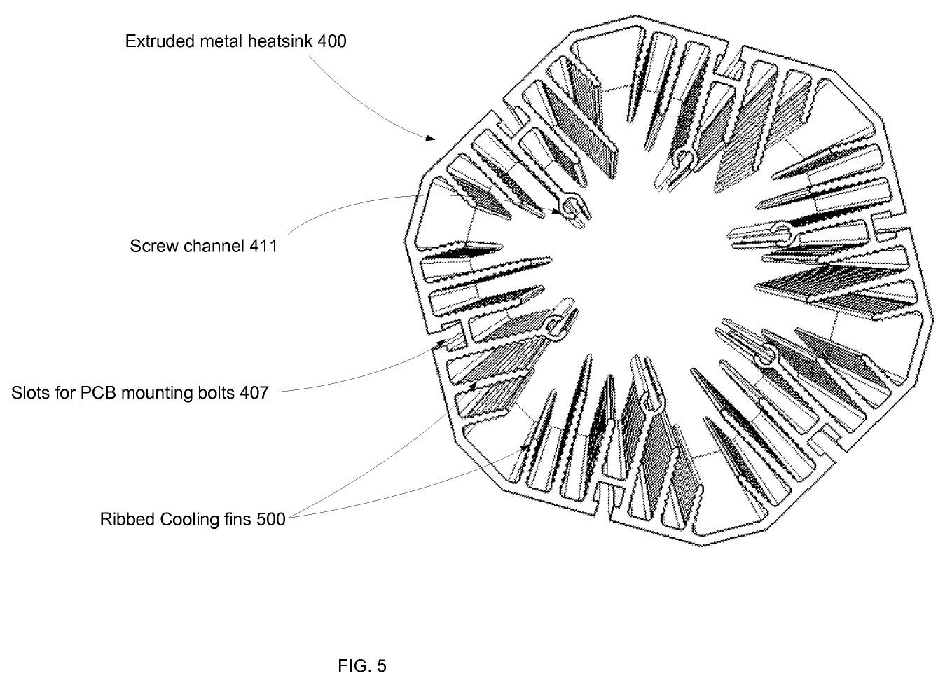

The extrusion profile of the hexagonal heat sink is shown in FIG. 5. This shows details of the screw channels 411 that support attachment of the plastic base, and slots 407 that hold the PCB mounting nuts 406 in place while PCB mounting bolts 405 are installed. The heat sink shown is extruded in one step without requiring additional steps for drilling or tapping holes. LED PCBs 401 are attached to the heat sink by first attaching the screws and nuts, and then sliding the nuts down the slots 407. A typical length of LED PCB is about 3 inches. The heat sink can be extruded as one long piece and cut to lengths to hold one, two, three, or more LED PCBs per side. FIG. 4 shows an example where the extruded heat sink has been cut to hold 2 PCBs per side. The same profile can be therefore used for products in a family with different amounts of total lumens, determined by the heat sink length and number of LED PCBs. The heat sink of FIG. 5 has ribbed cooling fins 500 on the inside. The internal fins with a ribbed profile increase the convection cooling area without significantly blocking the air flow through the central cavity. Natural convection cooling causes air to rise across the fins from below, thereby cooling the heat sink.

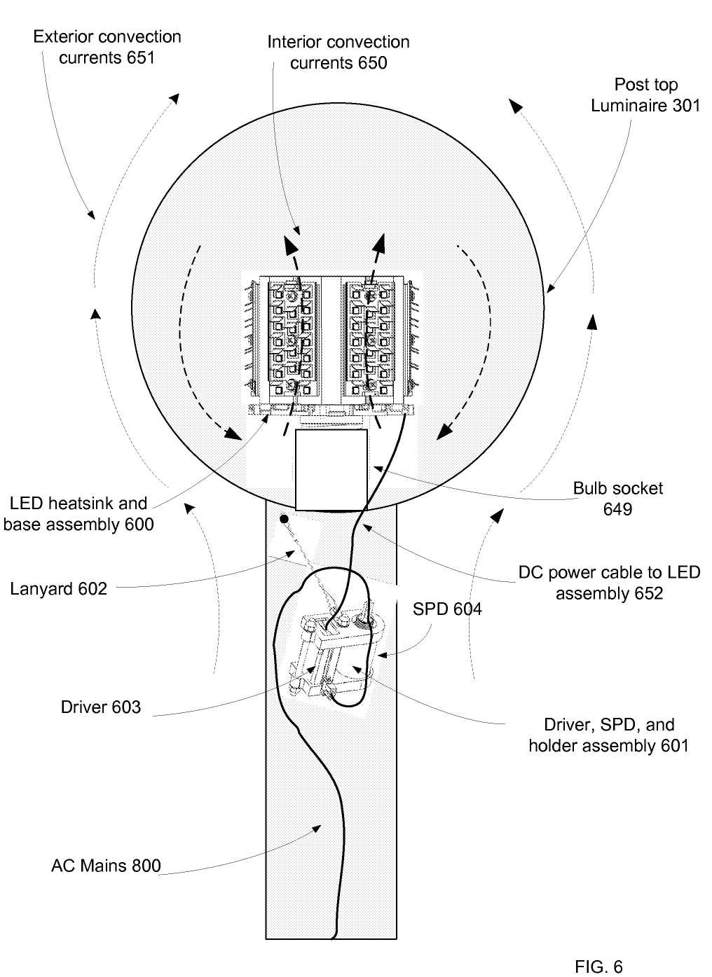

FIG. 6 shows a complete retrofit module mounted in a post top luminaire. The LED heat sink with base assembly 600 is screwed into the bulb socket of the legacy lamp 649. The LED driver 603 and optional surge protection device 604 (or SPD) are held in a separate assembly 601 that can be held in the fixture by means of a mounting lanyard 602. The assembly 601 is typically held in the same location in the fixture as the HPS ballast that is removed during the retrofit process. Locating the driver in a separate area from the LED assembly provides thermal isolation so that there is minimal heat transfer between the driver and the LED chips. Incoming AC mains 800 are connected to the driver assembly 601, and the DC output cable from the driver 652 is connected to the LED assembly 600. The embodiment illustrated in FIG. 6 has the LED PCBs and reflectors arranged symmetrically around the heat sink so that it generates a Type V distribution 206.

Dashed lines in FIG. 6 indicate how convection cooling cools the LED assembly 600. Inside the fixture, natural convection 650 causes air to rise through the internal channel of the heatsink, thereby transferring heat energy from the ribbed cooling fins to the air. The heated air rises and transfers its energy to the interior walls of the fixture 301. The heated fixture causes exterior convection air currents 651 to pass along the outer surface, thereby transferring heat energy from the fixture walls to the exterior air. The hollow heat sink 400 with internal fins therefore enables heat energy to be transferred from the LED chips to the air outside the fixture. For most efficient convection cooling, the heat sinks should be located in the lower section of the fixture with the components being arranged for the least amount of air flow restriction. However, the actual location of the retrofit inside the fixture is dictated by the socket location 649 and the appearance of the light through the glass or plastic enclosure. The placement of the LEDs relative to the socket can be adjusted by adjusting the overall length of the heatsink, or by adding a socket adaptor.

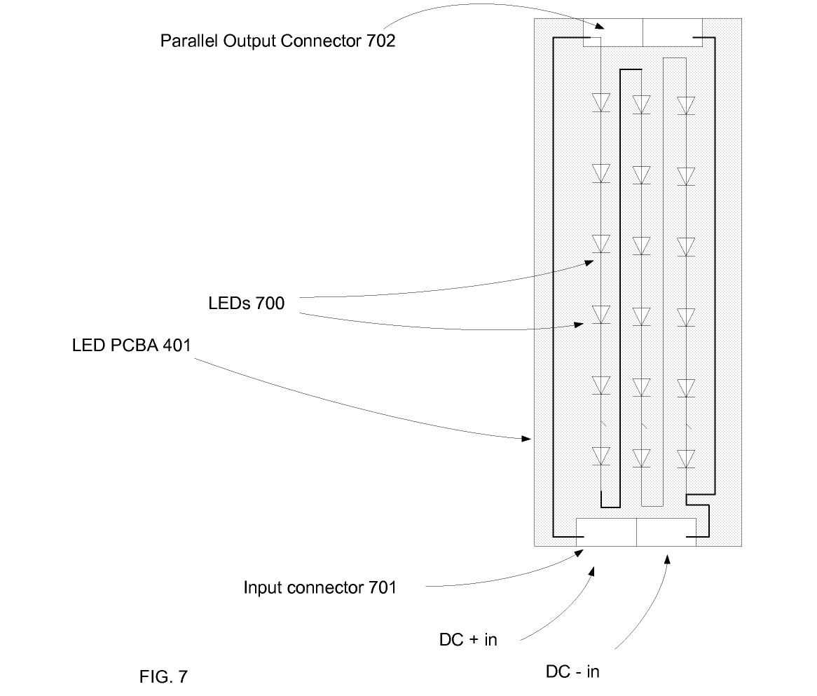

FIG. 7 shows an exemplary layout of the LED PCB 401. Eighteen LEDs 700 are laid out in a serial connection that is vertically symmetrical. In this example, three rows of six LEDs per row are connected in serial between two electrodes of the input connector 701. A second output connector 702 is connected in parallel with the input connector. The output connector 702 mates with the input connector 701 so that PCBs can be cascaded in an electrically parallel connection. For example, if a second PCB is connected to the output connector 702 and an input direct current is applied at the input connector 701, then the input current will be approximately split evenly between the two PCBs. In another embodiment, a chip on board (COB) module is used in place of each circuit board upon which LEDs are mounted.

The selection of number of LEDs per PCB and type of LED depends on the required total lumens from the retrofit. For example, if the required retrofit has a minimum target of 3000 lumens, then the LEDs in one PCB for a six-sided heat sink must generate at least 500 lumens. This can be met with three high-power LEDs of approximately 200 lumens each, or eighteen medium-power LEDs of approximately 30 lumens each. Lower lumens per LED can be preferred to reduce glare, but higher lumens per LED can be preferred to reduce cost, especially when the design uses one lens per LED. In either case, the driver is selected so that the net voltage drop across the LEDs falls within the output voltage range of the driver.

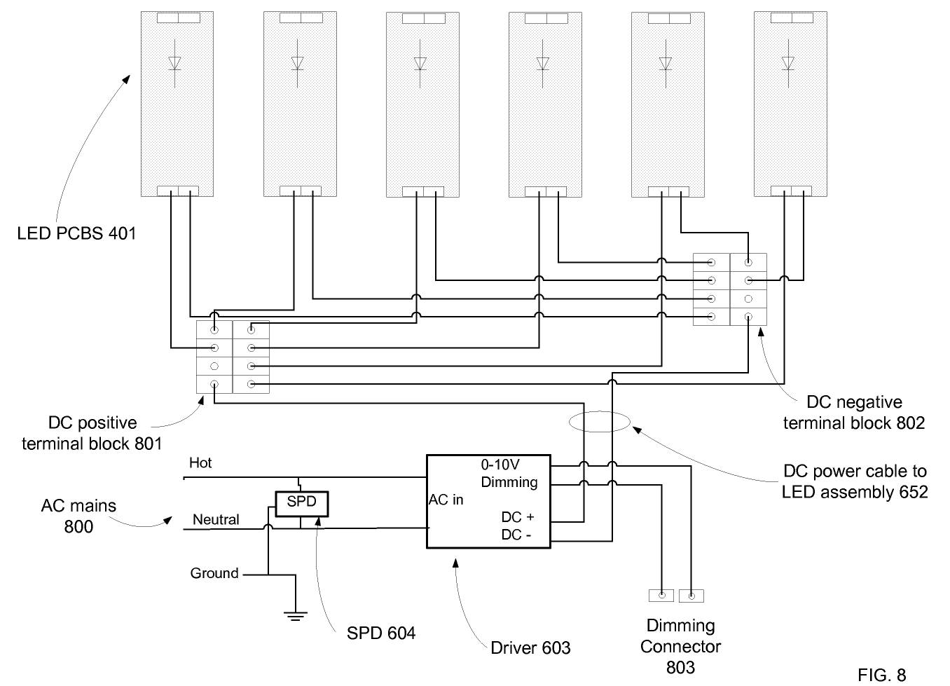

FIG. 8 shows an exemplary wiring diagram for the LED retrofit shown in FIG. 7. Power is delivered by the input alternating current mains 800 to the LED driver 603. An example of LED driver is the Roal Strato RSLD035-16 driver that delivers 700 mA of direct current to the LEDs with a DC voltage drop of 40-56 V. The optional SPD 604 is across the input AC mains to prevent lightning induced surges from damaging the LED components. The driver output DC leads are connected to a positive terminal block 801 and negative terminal block 802. The terminal blocks provide a fanout of the LED current so that it is divided approximately equally across the six LED PCBs. For example, if the total current from the driver is 600 mA, then the current per LED PCB (and hence per LED) will be 100 mA. In another embodiment, a thermistor can be placed on one of the LED PCBs to provide a feedback signal that depends on the LED temperature. This can be connected to a thermal feedback circuit in certain LED drivers so that the driver reduces the LED current when the PCB temperature reaches a predetermined threshold value. The LED driver has a dimming connector 803 that can be used for fixed or adjustable dimming of the LED module. A fixed resistor can be placed across the dimming connector 803 to reduce the LED current to a value between 10% and 100% of the full current, where the current level depends on the resistor value. Alternatively, the dimming connector can be connected to a control module that drives it with a DC signal between 0 and 10V. The control module supports remote control of the lighting level with control software controlling the dimming level. In general, dimming can be used to reduce the overall lumen output of the LED retrofit, and hence its power consumption.

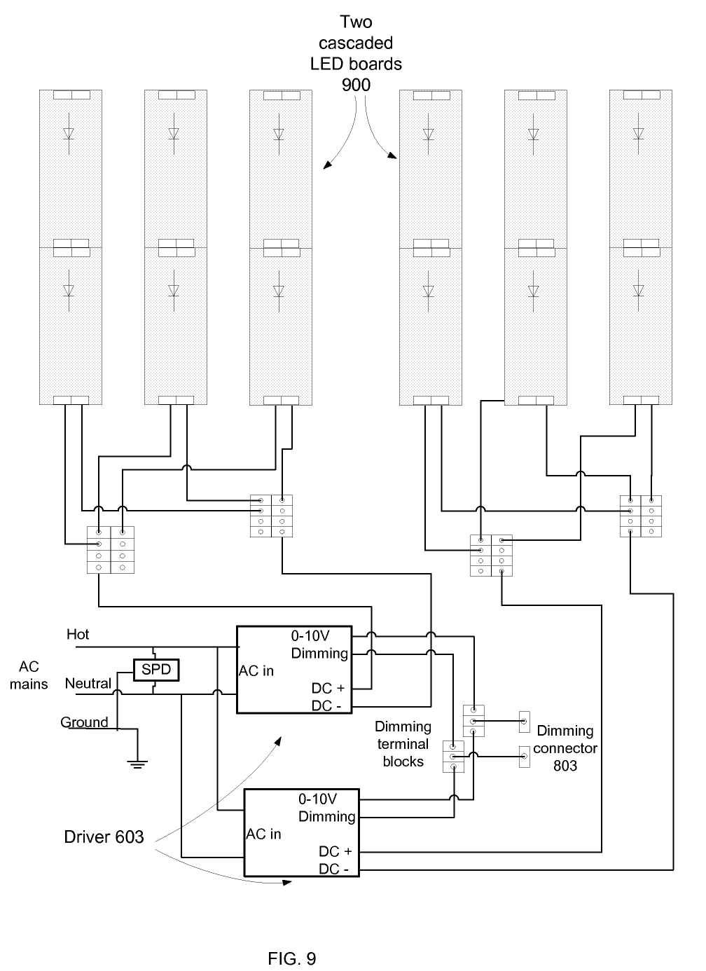

FIG. 9 shows an exemplary wiring diagram for the LED lightbulb replacement shown in FIG. 4. Compared to the embodiment of FIG. 8, the embodiment in FIG. 9 has two cascaded LED PCBs 900 per each side of the hexagonal heat sink, and two drivers. Without dimming enabled, this embodiment will consume approximately two times the power and deliver two times the lumens compared to the embodiment of FIG. 8. In this case each driver 603 has its current split between six LED PCBs. For example, if the total current from the driver is 600 mA, then the current per LED PCB (and hence per LED) will be 100 mA. As demonstrated, the same set of components can be configured to produce LED retrofits with an adjustable lumen output; a coarse adjustment is achieved means of adding more drivers and LED boards in parallel, and a fine adjustment is achieved by means of the driver dimming circuit. With multiple power supplies the connection of LED boards to the power supplies is preferably done in an interleaved fashion so that if one driver fails, the lighting distribution will still be roughly symmetrical around the luminaire. This can be preferable to the case where all the LED PCBs on one semicircle are connect to one power supply, so that in the event of a single driver failure only one side of the luminaire will remain lit. In another embodiment with multiple drivers with independent dimming controls the dimming level of each driver can be selectively set to adjust the light distribution around the luminaire.

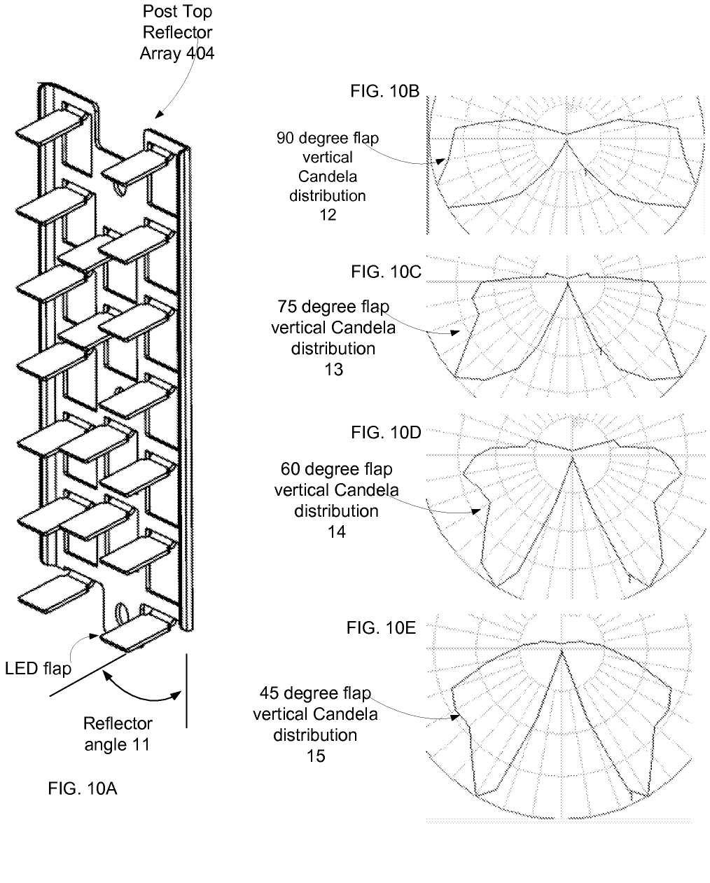

FIG. 10A illustrates details of the reflector array 404. As shown on the left, the array consists of a thin reflective material such as polished aluminum with punched out flaps that are positioned above each LED. The flap reflects light rays from the LED in a downwards direction. The vertical angle 11 of the flap can be set during the punching process, or adjusted afterwards by bending the flap with a mechanical jig. The reflector flaps redirect upwards light from each LED towards the ground so as to increase the ground lighting efficiency. FIGS. 10B-10E show how the vertical candela distribution of the luminaire 600 in FIG. 6 varies as the reflector flap changes. As the flap angle decreases from 90 degrees in FIG. 10B to 75 degrees in FIG. 10C to 60 degrees in FIG. 10D to 45 degrees in FIG. 10E, the peak candela decreases from 65 degrees to 30 degrees. In all cases the pole blocks the light at 0 degrees (straight down). The vertical angle of the candela distribution can thereby be adjusted by bending the flaps to the desired angle.

Although the reflector arrays reduce the amount of up light and provide a means of adjusting the vertical light distribution, there are embodiments that do not use the reflectors. For example, in decorative post top globes there may be a desire to evenly illuminate the globe so that reflectors are not required.

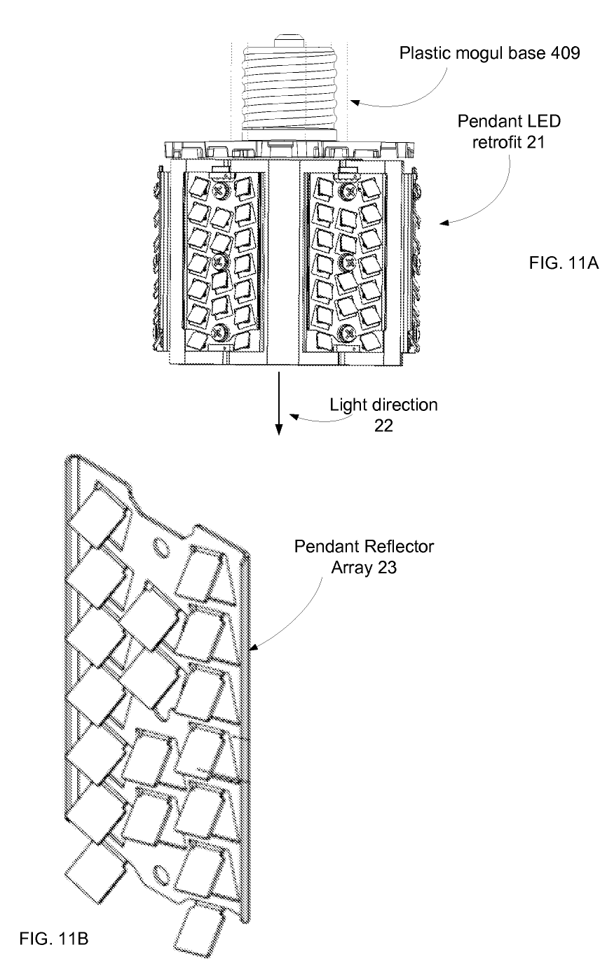

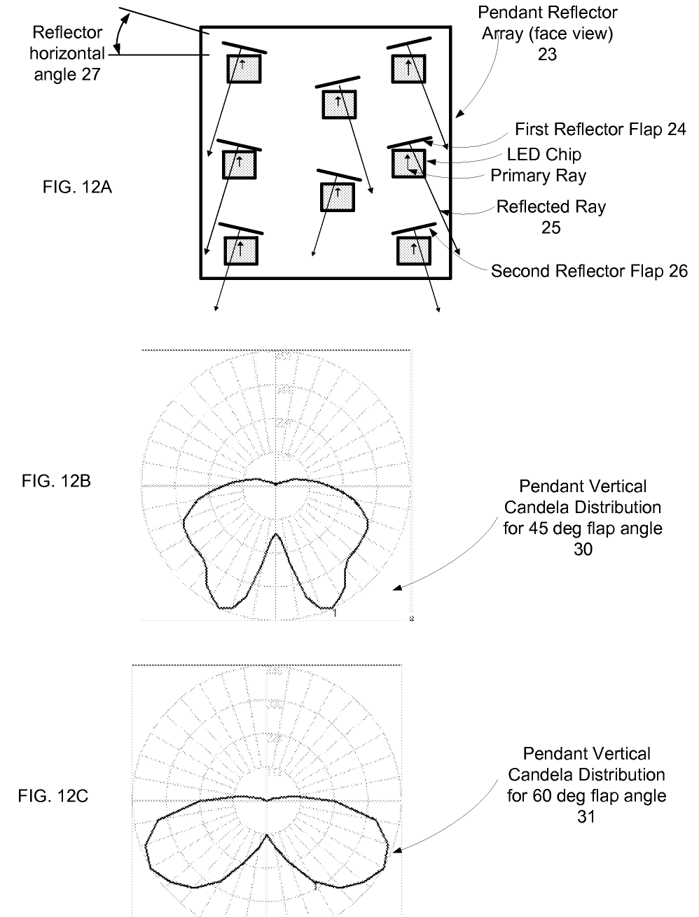

FIGS. 11A and 11B show details of the reflector array used in the pendant LED lightbulb replacement 21. For pendants, the retrofit is mounted with the socket side on top so the reflector array is designed to direct the light rays away from the socket and towards the ground. For the pendant, the ideal candela distribution 309 has light directly below the socket. To prevent reflected rays from a first reflector flap from hitting a second reflector flap, the flaps on the pendant reflector array 23 are angled towards a side away from the center of the reflector array. This detail is shown in FIG. 12A. The top diagram of FIG. 12A is a face view of the reflector array 23. The reflector flaps are angled fifteen degrees from the horizon 27 away from the middle of the pendant reflector array 23 so that the reflected ray 25 from a first reflector flap 24 passes by the second reflector flap 26. Therefore, rays from the LEDs can be reflected from the reflector flaps towards the ground without being reflected a second time in the upwards direction.

For the exemplary case of the pendant LED retrofit 21 with the pendant reflector array 23, the polar plot of FIG. 12B shows the vertical candela distribution 30 of the pendant for the case where the vertical reflector angle 11 is 45 degrees and the polar plot of FIG. 12C shows the vertical candela distribution 31 of the pendant for the case where the vertical reflector angle 11 is 60 degrees. The polar plots demonstrate (1) the pendant reflectors produce non-zero candelas at 0 degrees vertical, and (2) the pendant light distribution can be adjusted by changing the vertical reflector angle 11.

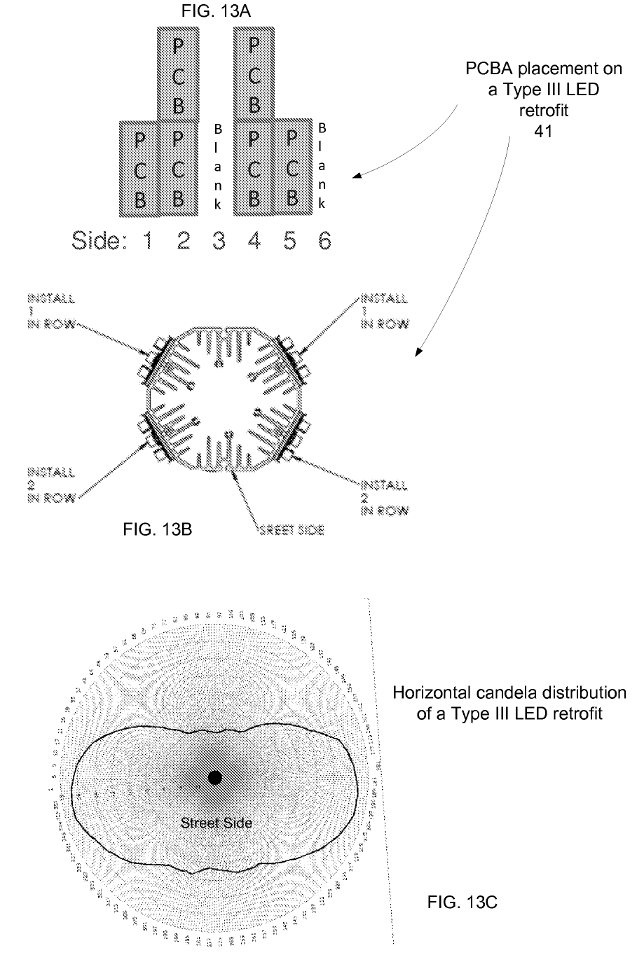

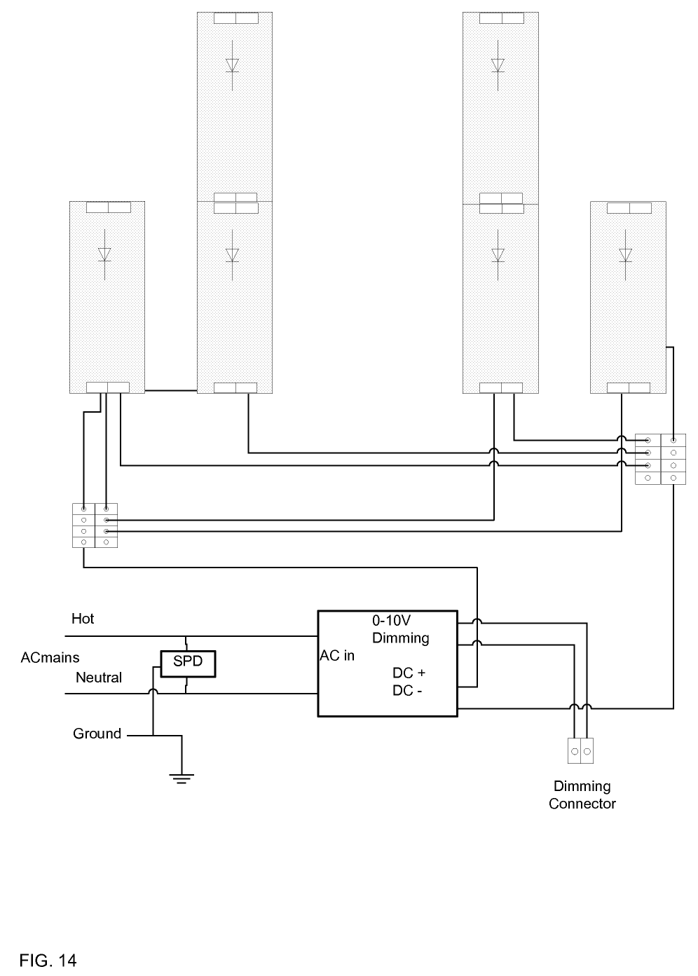

The invention can also be adjusted to produce different horizontal lighting distributions as defined in FIG. 2 by placing a different number of LED PCBs on different sides of the heat sink 41. An example of an embodiment that produces a Type III distribution 204 is shown in FIGS. 13A-13B. In this embodiment, the LED boards are placed around the heat sink as shown in the FIGS. 13A-13B as follows: (1) the side facing the street has no LED PCBs, (2) the two sides +/−60 degrees from the street side have two LED PCBs, (3) the two sides +/−120 degrees form the street side have one LED PCB, and (4) the side 180 degrees from the street side has no LED PCBs. The net horizontal candela distribution is shown in the polar plot of FIG. 13C. FIG. 14 illustrates the wiring diagram for the exemplary LED Type III placement shown in FIGS. 13A-13B. PCBs are cascaded with the parallel output connector on the side with two PCBs so that the drive current is divided equally between the six PCBs.

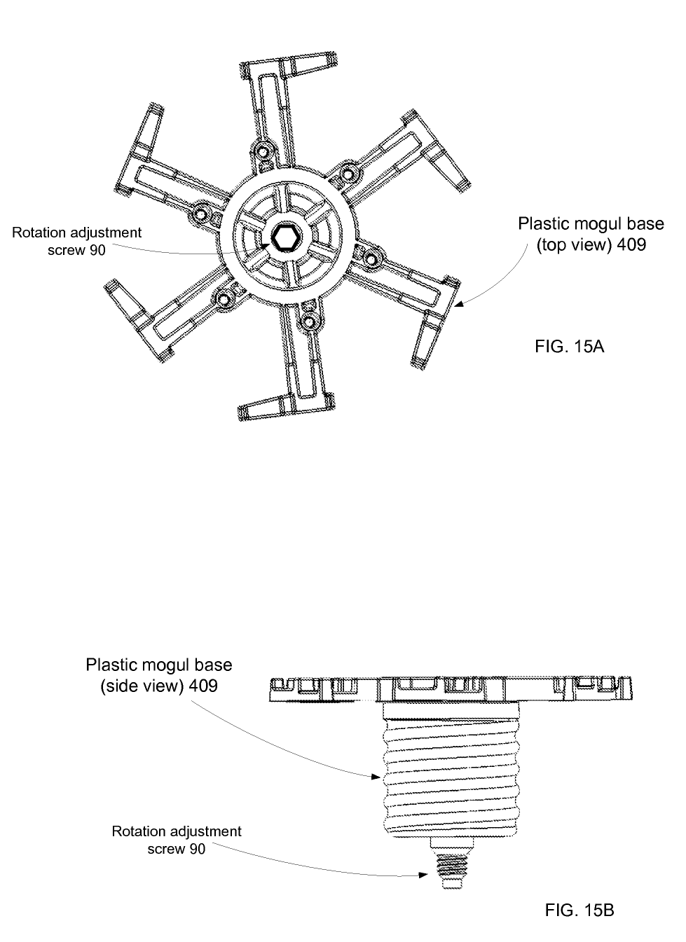

During installation, the LED retrofit for a Type III distribution must be rotated so that the designated street side of the retrofit is oriented towards the street. When the threaded base 409 is screwed into the luminaire socket, the street side of the retrofit will not necessarily end up facing the street. To provide this adjustment, an adjustment screw 90 is inserted at the base of the socket as shown in FIGS. 15A-15B. The rotation adjustment screw is rotated with an alien key from the top side of the base. To install the Type III LED retrofit the installer must follow these steps: (1) screw in the threaded base until it is tight within the socket, (2) unscrew the threaded base until the designated street side of the retrofit is facing the street, (3) use an allen wrench to tighten the adjustment screw until it contacts the bottom of the socket.

The embodiment illustrated in FIGS. 13A-B, FIG. 14, and FIGS. 15A-15B demonstrates how a Type III roadway distribution can be obtained by selectively placing a different number of PCBs on each side of the heat sink and rotating the LED retrofit so that the designated street side is facing the street. Those skilled in the art will recognize that in a similar manner, different numbers of LED PCBs can be placed selectively on the sides of the heat sink to obtain any of the IESNA roadway lighting distributions shown in FIG. 2. Furthermore, the reflector flap angle can be adjusted to control the spreading of the light rays from the LEDs. And the total lumens can be controlled by dimming the driver(s), or adding or subtracting PCBs and drivers. The invention therefore provides means of generating an LED lightbulb retrofit with adjustable horizontal and vertical candela distributions, adjustable total lumens, and adjustable mounting.

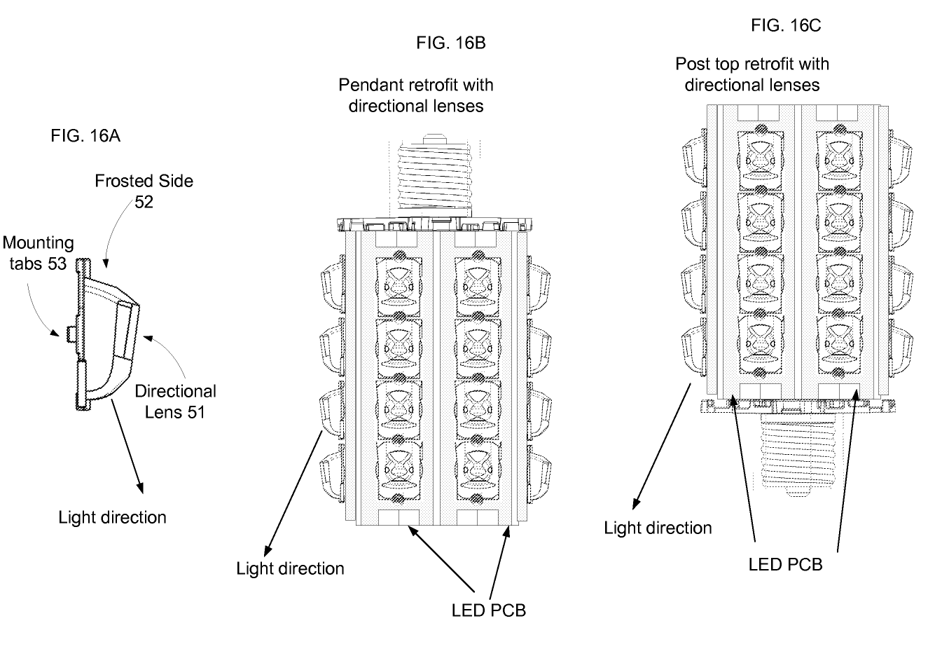

Another means of directing the light to the illumination area is directional lenses as shown in FIGS. 16A-16C. A commercial example of a forward throw lens is the C 12049 STRADA-FT product from Ledil Oy (www.ledil.com). This directional lens 51, shown in FIG. 16A, projects the light in one direction by reflecting internal light rays on a frosted side 52. It has mounting tabs to correctly place it on PCB relative to the LED. To mount this lens with the correct placement versus an LED, the LED printed circuit board (PCB) is designed with holes to accept the mounting tabs. The lens can be rotated relative to the PCB by 180 degrees to selectively direct the light in either direction at approximately 45 degrees relative to the PCB. The positioning tabs are centered so that the lens can be placed (a) with the reflective surface at the top to direct the light towards the socket, or (b) with the reflective surface at the bottom to direct the light away from the socket. FIG. 16B shows a pendant retrofit based on this lens and FIG. 16C shows a post top retrofit based on this lens. These assemblies are identical except that the lenses have been rotated by 180 degrees. As indicated, the light direction is away from the socket for the pendant, and towards the socket for the post top. A strip of lenses can be manufactured with a line of lenses and tabs. The individual lenses or strip of lenses can be held in place with screws so the end user can reverse the direction of light by removing the screws, turning around the lens, and replacing the screws. Those skilled in the art will recognize that similar results can be obtained with other lenses oriented around the socket.

Those skilled in the art will recognize that the scope of the invention is not limited to the examples presented. For example, a hexagonal extrusion profile was presented but similar results can be obtained with other shapes, such as a heptagon. Similarly, although the exemplary LED PCBs have eighteen or four LEDs per PCB, PCBs with a different number of LEDs will provide similar results. Furthermore, the presented examples are based on a driver that shares its current with PCBs connected in parallel, whereas the PCBs can also be connected in series. The exemplary embodiments were simplified with PCBs holding only LEDs and connectors, adding other circuitry to the PCBs does not depart from the scope of the invention. The exemplary embodiments disclose the case where the Edison socket is used for mechanical mounting only, but the scope of the invention also covers the case where the socket is also used to provide electrical power to the LEDs with power conversion circuitry on the LED PCBs or other PCB attached to the LED retrofit. The exemplary reflector array has flaps with a flat, angled geometry; the flaps can also have a curved geometry as a means of further controlling the light distribution. For example, a curved flap with a parabolic shape can be used to collimate the light towards a target angle.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A light emitting diode (LED) light bulb replacement apparatus, comprising:
a plurality of circuit boards or chip on board modules upon which LEDs are mounted;
a multi-sided heat sink with internal fins, wherein one or more circuit boards or chip on board modules are mounted on one or more sides of the heat sink;
the heat sink being arranged about an axis with the fins on the heat sink facing the axis to allow convective air flow across the fins;
an airflow cavity defined by a volume around the axis and inside the fins of the heat sink; and
opposite ends of the axis being open to enable airflow through the airflow cavity along the fins of the heat sink.

2. The light emitting diode light bulb replacement apparatus of claim 1, wherein the internal fins are ribbed to increase a surface area of the fins without significantly impeding an air flow cross-sectional area.

3. The light emitting diode light bulb replacement apparatus of claim 1, wherein the heat sink is attached to one of a plurality of interchangeable mechanical bases that can be mounted in or on legacy light sockets; and
the interchangeable mechanical bases have arms mounting to the heat sink that do not significantly block air flow through the airflow cavity.

4. The light emitting diode light bulb replacement apparatus of claim 1, wherein:
the LEDs are mounted on the plurality of circuit boards, and
a total number of the circuit boards on each side of the heat sink are adjusted to approximate an ideal light distribution.

5. The light emitting diode light bulb replacement apparatus of claim 1, wherein the LEDs are mounted on the plurality of the chip on board (COB) modules.

6. The light emitting diode (LED) light bulb replacement apparatus of claim 1, wherein:
the heat sink being attached to one of a plurality of interchangeable mechanical bases that can be screwed into legacy light sockets;
a rotational orientation of the heat sink relative to a light fixture being adjustable by a set screw;
a total number of LED circuit boards being adjusted by a parallel output connector and cutting a length of the heat sink; and
a light distribution in a plane orthogonal to the axis being adjusted by mounting the plurality of circuit boards or chip on board modules symmetrically or asymmetrically on the one or more sides of the heat sink.

7. The light emitting diode light bulb replacement apparatus of claim 6, wherein the light distribution in the plane containing the axis is adjusted by an array of reflective flaps with adjustable angles, and
wherein the array of reflective flaps is positioned such that each flap in the array of reflective flaps reflects a substantial amount of rays from a single LED.

8. The light emitting diode light bulb replacement apparatus of claim 6, wherein:
the light distribution in the plane containing the axis is adjusted by a plurality of lenses positioned such that each lens focuses a substantial amount of rays from a single LED; and
each lens has a different mounting orientation relative to the LEDs.

9. A light emitting diode (LED) light bulb replacement apparatus, comprising:
a plurality of circuit boards or chip on board modules upon which LEDs are mounted; and
an array of reflective flaps mounted over the plurality of circuit boards or chip on board modules such that each flap reflects a significant portion of rays from one or more LEDs towards an illumination area;
wherein an angle and a shape of each reflective flap can be adjusted to control a distribution of reflected rays reflected by the each reflective flap.

10. A light emitting diode (LED) light bulb replacement apparatus, comprising:
a plurality of circuit boards or chip on board modules upon which LEDs are mounted; and
a plurality of directional lenses with each lens mounted over the plurality of circuit boards or chip on board modules so as to direct a substantial amount LED light rays in a preferred direction, wherein the mounting of the lenses is adjustable so that more than one preferred direction can be achieved by mounting the lenses with more than one orientation.
